(19) United States
(12) Patent Application Publication
(10) Pub. No.: US 2023/0124593 A1
(43) Pub. Date: Apr. 20, 2023

(54) SYSTEMS AND METHODS FOR AUTOMATED SERVICES INTEGRATION WITH DATA ESTATE

(71) Applicant: Microsoft Technology Licensing, LLC, Redmond, WA (US)

(72) Inventor: Rahul GUPTA, Hyderabad (IN)

(21) Appl. No.: 17/503,115

(22) Filed: Oct. 15, 2021

(51) Int. Cl. G06N 3/04; G06N 3/08; G06F 16/28; G06F 11/34

(52) U.S. Cl. CPC G06N 3/0436; G06N 3/0454; G06N 3/08; G06F 16/288; G06F 11/3409

(57) ABSTRACT

An automated workflow process for integration of services with a data estate of an external entity. A plurality of application data models are obtained that are associated with of a plurality of applications on a cloud-based platform. A data model is obtained that corresponds to a collection of data to be processed. Mappings are determined between the data model and the plurality of application data models. A candidate application of the plurality of applications is identified for processing the collection of data based on the mappings. A communication suggesting the candidate application for processing the collection of data is sent to the external entity over one or more networks.

### BACKGROUND

The present disclosure relates to a computing system and, more particularly, to automated processes for integrating data with third party applications.

Customer engagement with computing services generates large volumes of data that is stored and maintained in cloud storage. This data is of immense value to organizations for improving their engagement, quality of service, and reputation. To improve value and glean insight into this data, organizations providing such computing services may wish to analyze such data via domain-specific solutions provided by third parties. For example, in the retail domain, analysis of customer behavior data obtained by a retailer (e.g., Walmart) may provide insights in how to improve end consumer experience.

In at least some instances, such organizations may be unequipped with a means for appropriately and efficiently analyzing this data and development of solutions to analyze data for each project would be expensive and time-consuming. Third party services may be available that could provide the functionality to analyze collections of data for individual projects. However, a significant drawback for using these third-party solutions is that the data may be in a form that is not immediately usable by the third-party solution. As a result, a considerable amount of time, effort, and expense is typically dedicated to formatting or processing the data or modifying the third-party solution so that the data and solution can be integrated. Moreover, there is a high magnitude of computational power (e.g., cardinality) involved in identifying how or which third party solutions can be integrated with the data.

### BRIEF DESCRIPTION OF THE DRAWINGS

FIG. 1 shows an illustrative environment in which an automated workflow process may be implemented according to one or more embodiments.

FIG. 2 shows an illustrative environment in which an automated workflow process is implemented according to one or more embodiments.

FIG. 3 shows an illustrative environment in which an automated workflow process is implemented according to one or more embodiments.

FIG. 4 illustrates an environment in which one or more neural networks associated with a mapping service are trained according to one or more embodiments.

FIG. 5 shows a method for determining a set of candidate applications or services for processing data associated with an external entity according to one or more embodiments.

FIG. 6 illustrates a simplified block diagram of an example computer system according to one or more embodiments.

FIG. 7 illustrates a illustrates an artificial neural network processing system according to one or more embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein. Furthermore, well-known features may be omitted or simplified to avoid obscuring the techniques being described. The term “set” (e.g., “a set of items”), as used herein, refers to a nonempty collection comprising one or more members.

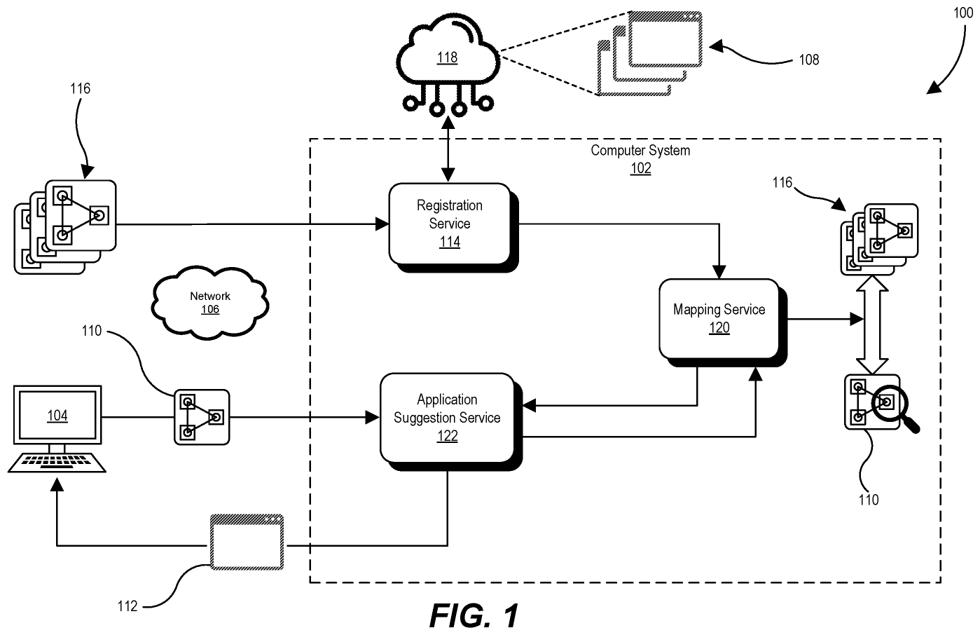

FIG. 1 shows an illustrative environment 100 in which an automated workflow process may be implemented according to one or more embodiments. In the environment 100, a computer system 102 is configured to execute an automated workflow process for determining a set of candidate applications or services for processing data associated with an external entity. The computer system 102 communicates with a requestor 104 associated with the external entity over one or more networks 106. The external entity may be a corporate entity active in one or more industries, such as retail, energy, financial technologies, and/or healthcare, by way of non-limiting example. The external entity possesses one or more data sets to be analyzed, evaluated, or otherwise processed, but the external entity does not possess a solution sufficient to process the one or more data sets. A plurality of third-party applications or services 108 are accessible to the computer system 102, one or more of which may provide functionality sufficient to process the one or more data sets. In at least some previously-implemented systems, identifying which of the plurality of applications 108 are configured to process the one or more data sets is a complex problem that would involve a significant amount of time and manual review to accomplish.

The computer system 102 is configured to obtain a data model 110 of the one or more data sets to be processed and determine an application 112 of the plurality of applications 108 that is compatible with or has an appropriate correlation with the data model 110. The data model 110 may be provided by the requestor 104 or may be generated by the computer system 102 based on the one or more data sets to be processed. More particularly, the computer system 102 determines that the application 112 has features that correlate to data attributes of the data model 110, as described in further detail herein.

The requestor 104 may include one or more computing systems (e.g., servers, laptops, processor-based devices) equipped to submit a request, via a communication interface or function call, for instance, to the service that causes the service to execute the automated workflow process. As described herein, the automated workflow process may be directed to executing one or more functions in fulfillment of the request (e.g., mapping data models, suggesting an application). The workflow process may cause the service to interact with one or more other services to fulfill the request.

The computer system 102 may provide or recommend the application 112 to the requestor 104 as a candidate for processing the one or more data sets. In some embodiments, the computer system 102 may evaluate the compatibility or appropriateness of the application 112 based on interactions with the application 112 by the requestor 104. The computer system 102 may modify various operational aspects for determining the application 112 based on the evaluation of the compatibility of the application 112.

The computer system 102 includes a registration service 114 that is configured to register the plurality of applications 108 to be considered as candidates for the application 112 to be determined. The plurality of applications 108 may be stored or maintained on a cloud-based platform 118, such as Azure® Marketplace. The registration service 114 is also configured to obtain a plurality of data models 116 that are respectively associated with the plurality of applications 108. In some instances, one or more data models of the plurality of data models 116 are provided by third parties who provide the plurality of applications 108 for access on the cloud-based platform 118. In some instances, one or more data models of the plurality of data models 116 may be derived based on one or more data sets associated with corresponding applications of the plurality of applications 108. For instance, a third party providing one of the applications 108 may provide one or more data sets successfully processed using the application. In some embodiments, the computer system 102 may be part of the cloud-based platform 118.

The computer system 102 also includes a mapping service 120 that receives the data model 110 and performs comparisons between the data model 110 and one or more of the plurality of data models 116. The mapping service 120 generates, based on the mapping performed, one or more indications regarding correlations between the data model 110 and the plurality of applications 116. For example, the one or more indications may include numerical representations regarding compatibility of the data model 110 with corresponding applications of the plurality of applications 108 that are associated with the plurality of data models 116. As another example, the one or more indications may include a score indicating compatibility of the data model 110 with a set of the applications 108. In some embodiments, the mapping service 120 may recommend a set of the applications 108 as being the most compatible or having higher correspondence with the data model 110.

The computer system 102 further includes an application suggestion service 122 that suggests the application 112 to the requestor 104. The application suggestion service 122 may obtain the data model 110 and provide the data model 110 to the mapping service 120 in connection with a request to map correspondences between the data model 110 and the plurality of data models 116. As a result of the output received from the mapping service 120 in response to the request, the application suggestion service 122 may provide the application 112 as a recommendation for processing the one or more data sets associated with the data model 110. The application suggestion service 122 may observe interaction of the requestor 104, e.g., on the cloud-based platform 118, and perform an evaluation regarding the output provided by the mapping service 120. The application suggestion service 122 may then provide a result of the evaluation as a basis for modifying operation of the mapping service 120.

The computer system 102 may comprise one or more processor-based devices that are configured to perform the operations described herein. By way of non-limiting example, the computer system 102 may include one or more servers that include one or more processors (e.g., processing units, microprocessors) executing instructions that cause the computer system 102 to implement the registration service 114, the mapping service 120, and the application suggestion service 122. Each processor-based device typically will include an operating system that provides executable program instructions for the general administration and operation of that device and typically will include or have access to a computer-readable storage medium (e.g., a hard disk, random access memory, read only memory, etc.) storing instructions that, as a result of being executed by a processor, cause the device to perform its intended functions.

The environment 100, in one embodiment, is a distributed and/or virtual computing environment utilizing several computer systems and components that are interconnected via communication links, using one or more computer networks and/or network connections. However, it will be appreciated by those of ordinary skill in the art that such a system could operate equally well in a system having fewer or a greater number of components than described herein.

The registration service 114, the mapping service 120, and the application suggestion service 122 are operated in connection with or as part of one or more cloud computing services and/or applications provided by a computing services provider. In some embodiments, the registration service 114, the mapping service 120, and/or the application suggestion service 122 are components of one or more cloud computing services and/or applications of a computing services provider. In some embodiments, the registration service 114, the mapping service 120, and/or the application suggestion service 122 are called or initiated by one or more cloud computing services and/or applications of a computing services provider. The registration service 114, the mapping service 120, and/or the application suggestion service 122 may be implemented as executable instructions stored on one or more non-transitory computer-readable media that, as a result of execution by one or more processors, cause the computer system 102 to operate as described herein.

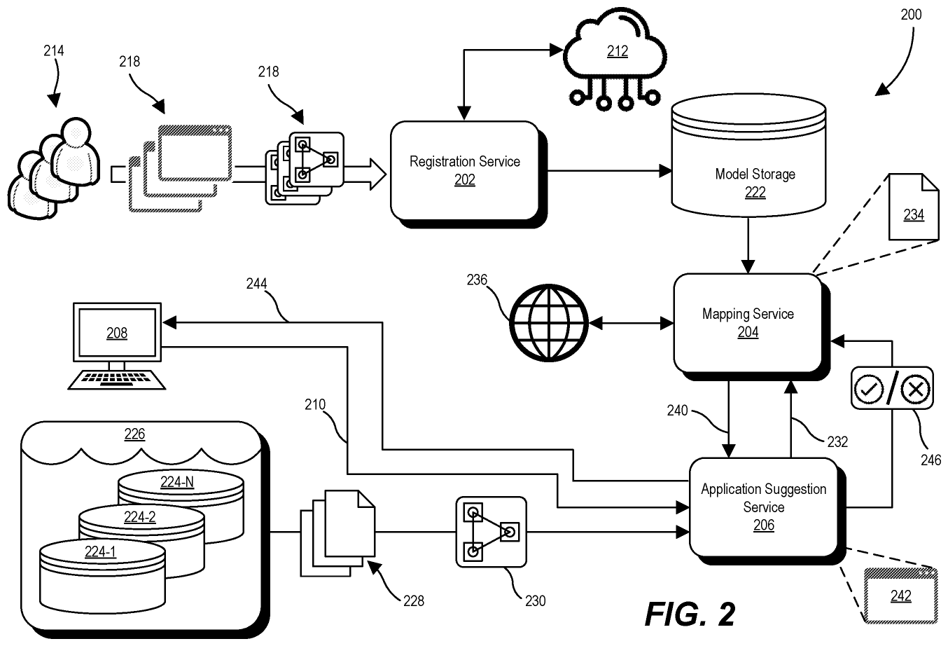

FIG. 2 shows an example of an environment 200 in which an automated workflow process is implemented according to one or more embodiments. The environment 200 includes a computer system comprising a registration service 202, a mapping service 204, and an application suggestion service 206 that are provided by a computing services provider, as described with respect to FIG. 1 and elsewhere herein. An entity 208 external to the computing services provider may send a request 210 over one or more networks to the computing services provider to process a volume of stored data. For instance, a retailer may provide a request to the computing services provider to process a volume of stored customer data. The computing system of the computing services provider obtains a data model of the stored data, processes the data model, and provides an indication regarding one or more applications or services that may be configured to integrate with at least some of the stored data.

Third party entities that are independent and separate from the cloud computing service provider may register with the cloud computing service provider to make their independent applications available on a platform 212 of the cloud computing service provider. A non-limiting example of the platform 212 is Azure Marketplace by Microsoft®. More particularly, a third-party entity 214 may register one or more application(s) 216 with the registration service 202 of the cloud computing service provider. In connection with or as a part of registration with the registration service 202, the entity 214 provides one or more application data models 220 that describe attributes, structures, semantics, etc., of data to be provided as input to the associated application(s) 216. The application data model 220 may include information regarding data objects (e.g., data type, size), associations between data objects, schema describing how the data is structured (e.g., logical schema, physical schema), or other such attributes. The application data model(s) 220 may be in the form of an extensible markup language (XML) schema definition (XSD), a database file, or other similar form for encoding data in a structured format. In some embodiments, the registration service 202 may receive one or more sample input data sets used as input to an associated application 216. In such embodiments, the registration service 202 may be configured to generate, or to call upon another service to generate, the application data model(s) 220 based on the one or more sample input data sets.

The registration service 202 stores the application data model(s) 220 in data model storage 222. The application data model(s) 220 may be stored in connection with information regarding or identifying the application 216 with which the application data model 220 is associated. For instance, the registration service 202 may update a table, index, or other similar record to indicate an association between the application data model 220 and the corresponding application 216 available on the platform 212.

The entity 208 stores or maintains data to be processed in a set of data sources 224-1, 224-2, . . . 224-N (collectively “data sources 224”), which are data storage volumes or locations, such as databases, hard drives, or cloud storage, by way of non-limiting example. The data sources 224 may be aggregated in a common or unified data store 226. Non-limiting examples of the common data store 226 include a data lake in which raw copies of source data from the data sources 224 is stored in a native format, and a data warehouse in which source data from the data sources 224 is integrated and stored (e.g., via Microsoft® Azure Data Factory).

In connection with the request 210, the application suggestion service 206 may receive information regarding or identifying data 228 to be processed. As a non-limiting example in which the entity 208 is a retailer, the request 210 may identify a collection of customer-related data specifying goods, associated prices, quantity available, quantity purchased, associated dates, and locations/sites at which the goods are available. The application suggestion service 206 obtains a data model 230 of the data 228 to be processed. In some embodiments, the entity 208 may send the data model 230 to the application suggestion service 206 or provide an identifier of the data model 230 for locating the data model 230 in the common data store 226 (e.g., a network location). In some embodiments, the application suggestion service 206 may be configured to generate the data model 230 based on the data 228 to be processed. For instance, the application suggestion service 206 may obtain the data 228 to be processed and generate the data model 230 based on the data 228. In some embodiments, the application suggestion service 206 may instruct another service to generate the data model 230 using the data 228.

In response to the request 210, the application suggestion service 206 sends a call or request 232 to the mapping service 204 to generate a mapping for the data model 230. In response, the mapping service 204 obtains the data model 230 and performs comparisons between the data model 230 and the plurality of application data models 220 stored in the model storage 222. More particularly, the mapping service 204 may compare entries in the data model 230 with entries in the plurality of application data models 220 and determine a correspondence therebetween. As an example, the mapping service 204 may determine, for each entry in the data model 230, whether there is a matching entry in a candidate data model of the plurality of application data models 220.

Based on results of the comparisons, the mapping service 204 may update a data structure 234 (e.g., an index, a table) stored in memory that indicates a correlation or a similarity between the data model 230 and a set of the application data models 230. In some embodiments, the mapping service 204 may update the data structure 234 to indicate a correspondence of individual entries of the data model 230 with matching entries of the set of application data models 220, if any. The mapping service 204 may provide the data structure 234 or a subset of information contained therein in fulfillment of the request 232.

In some embodiments. the mapping service 204 includes one or more neural network models that are trained to determine a mapping between the data model 230 and the plurality of application data models 220. The mapping service 204 may be configured to autonomously search or crawl the internet 236 for relevant data sets, applications, data models, etc., to train the one or more neural networks. In some embodiments, the mapping service 204 includes encoded logic for implementing one or more heuristic functions that assess the similarity of entries in the data model 230 to entries in the application data models 220. As a more specific non-limiting example, simple heuristics may be employed to identify a match or a partial match based on a data type names (e.g., “price”, “quantity”), symbols (e.g., “$”, “%”), or relationships between data types or data items (e.g., formulas, links). In some embodiments, the mapping service 204 may implement fuzzy hashing to determine similarities between the data model 230 and the plurality of application data models 220.

The mapping service 204 may implement a combination of techniques (e.g., fuzzy hashing, heuristics, neural networks) to determine a set of application data models 220 with a highest correlation or similarity to the data model 230. In some implementations, the mapping service 204 may perform a multi-step process for mapping the data models. For instance, in a first step, the mapping service 204 may implement heuristics or fuzzy hashing to determine a first set of candidate data models of the application data models 230 to be evaluated. Then, in a second step, the mapping service 204 may evaluate the first set of candidate data models using one or more neural networks to determine a second set of candidate data models with the highest similarity. As a result of using a multi-step approach, an amount of computing resources utilized to determine the most compatible application(s) based on the data model 230 may be reduced relative to a single-step approach.

The mapping service 204 provides a response 240 to the application suggestion service 206 indicating a result of the mapping performed. For instance, the response 240 may include at least a portion of the data structure 234 that indicates a set of the application data models 220 having a highest degree of similarity or compatibility with the data model 230. In some embodiments, the response 240 may include values correlating individual entries in the data model 230 with entries in the application data models 220. In some embodiments, the response 240 may include numerical values or “scores” indicating a similarity or correlation between individual data models of the application data models 220 and the data model 230. In some embodiments, the response 240 may identify a plurality of values that each correspond to a different aspect of data model correlation. For instance, one numerical value may correspond to a correlation between data types in the data model (e.g., type of product, price, quantity), another numerical value may correspond to a correlation between structure of the data models, a further numerical value may correspond to relationships between data types and/or data items, and so on.

Based on the response 240, the application suggestion service 206 determines one or more applications 242 on the platform 212 that have a highest degree of compatibility with the data model 230. The application suggestion service 206 may determine which application(s) 242 are the most compatible based on which of the application data models 220 have the highest numerical values (e.g., top five highest values). The application suggestion service 206 sends a communication 244 to the requestor 208 recommending the applications 242 for processing the data 228.

The application suggestion service 206, in some embodiments, may detect or monitor engagement (or the lack thereof) of the requestor 208 with the application(s) 242 suggested in the communication 244. The application suggestion service 206 may detect, via the platform 212, whether the requestor 208 accesses any of the application(s) 242 suggested and, if so, which of the applications 242 the requestor 208 accesses. The application suggestion service 206 may detect the degree to which the requestor 208 uses any of the application(s) 242 to process the data 228—for example, whether the requestor 208 successfully processes the data 228 using any of the application(s) 242 suggested. In some embodiments, the application suggestion service 206 may detect which of the application(s) 242 the requestor 208 fails to interact with. In some embodiments, the application suggestion service 206 may detect whether the requestor 208 discontinues using any of the application(s) 242 suggested with minimal use or after processing a portion of the data 228.

The application suggestion service 206 may generate feedback data 246 based on the interactions of the requestor 208 with the application(s) 242 suggested and provide the feedback data 246 to the mapping service 204. The feedback data 246 may indicate, for example, which of the application(s) 242 the requestor 208 interacted with, the degree of interaction, which of the application(s) 242 the requestor 208 avoided interaction with, etc. The mapping service 204 may, in some embodiments, modify its mapping performance by using the feedback data 246 as training data for a neural network.

Advantageously, a computer system comprising the registration service 202, the mapping service 204, and the application suggestion service 206 improves the efficiency of using a platform, such as the platform 212, that includes a multitude of third-party applications. Previously, users who wished to process a large volume of data using commercially available software were tasked with identifying candidate applications and determining which, if any, of the candidate applications are suitable for processing their data. The computer system disclosed herein identifies one or more compatible applications, thereby reducing or eliminating the experimental process of sorting through candidate applications and improving user efficiency in utilizing the platform as a whole.

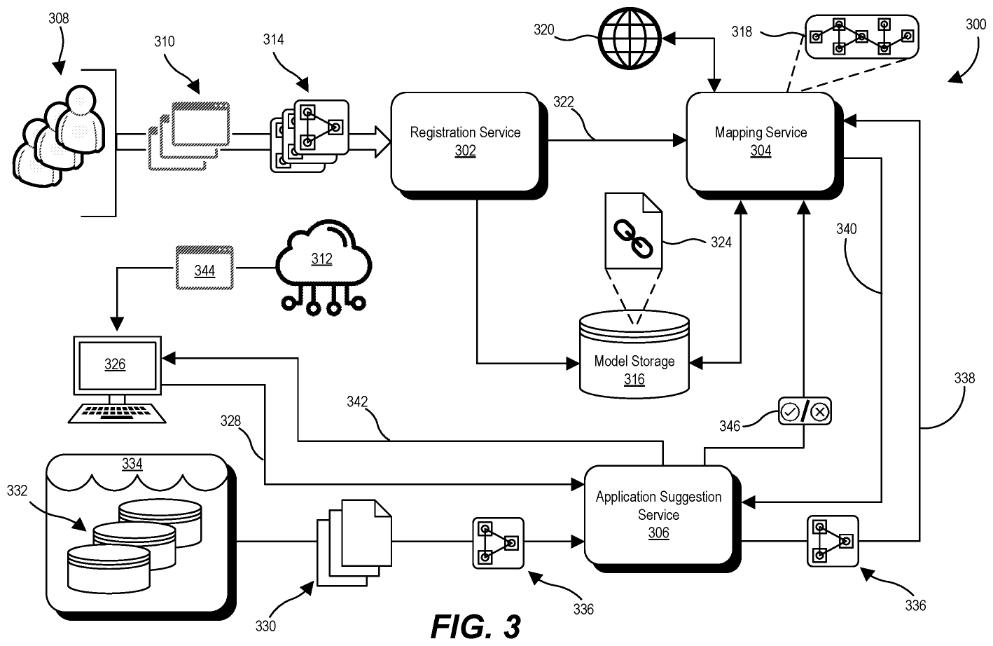

FIG. 3 shows an example of an environment 300 in which an automated workflow process is implemented according to one or more embodiments. The environment 300 includes a computer system comprising a registration service 302, a mapping service 304, and an application suggestion service 306 that are provided by a computing services provider. Various features of the environment 300 are substantially similar to features described with respect to FIGS. 1 and 2, so further description thereof is omitted for brevity.

As described with respect to FIG. 2, a plurality of third-party entities 308 may each register with the registration service 302 of the cloud computing service provider to make one or more applications or services 310 available on a platform 312 of the service provider. In connection with or as a part of registration with the registration service 302, the entities 308 may provide one or more application data models 314 that describe attributes, structures, semantics, etc., of data to be provided as input to the associated application(s) 310. In some embodiments, the registration service 302 may be configured to generate, or to call upon another service to generate, the application data model(s) 314 based on the one or more sample input data sets received from the entities 308.

The registration service 302 stores the application data model(s) 314 in data model storage 316. The application data model(s) 314 may be stored in connection with information regarding or identifying which of the applications 310 each of the application data models 314 is associated.

The mapping service 304 is configured to generate a comprehensive data model 318 based at least in part on a plurality of data models. The comprehensive data model 318 is an extensive collection of data types, structures, schema, relationships or associations between data types, etc., that provide a blueprint for defining a data estate. The mapping service 304 may be configured with logic (e.g., executable instructions, hard wired logic) for understanding semantics and syntax in the context of data models, customer data, and other available sources of information. The mapping service 304 may have access and be configured to crawl the internet 320 for relevant data, data models, and schema to generate and/or update the comprehensive data model 318. The mapping service 304 may be configured to generate and/or update the comprehensive data model 318 based on the plurality of data models 314 obtained via the entities 308. In some embodiments, the mapping service 304 may include one or more neural networks trained to generate the comprehensive data model 318 based on various data sources described herein.

In some implementations, the comprehensive data model 318 may be specific to an industry or technology. By way of non-limiting example, the comprehensive data model 318 may be specific to retail, healthcare, energy (e.g., oil, solar, wind), transportation, or manufacture. In some embodiments, the mapping service 304 may be configured to generate a plurality of comprehensive data models that are each specific to an industry or technology.

The registration service 302 sends a request 322 causing the mapping service 304 to map one or more of the application data models 314 obtained with the comprehensive data model 318. For an individual model of the application data models 314, the mapping service 304 determines links or correlations between attributes of each individual model and the comprehensive data model 318. For instance, the mapping service 304 may determine that a data type in the individual model has a corresponding data type in the comprehensive data model 318, or that a relationship between data types or items in the individual model has a corresponding relationship in the comprehensive data model 318.

In some embodiments, the mapping service 304 generates a model map 324, which is a data structure identifying the correlations between attributes in comprehensive data model 318 and attributes in the application data models 314. In the model map 324, there may be a one-to-many correspondence between an attribute in the comprehensive data model 318 and attributes of the application data models 314. As a more specific example, the model map 324 may indicate that a data type in the comprehensive data model 318 has a correspondence with a first data type in a first application data model and a correspondence with a second data type in a second application data model. The model map 324 may be stored in the model storage 316 and may include information identifying the applications 310 with which each of the data models 314 mapped are associated. In some embodiments, the mapping service 304 may include one or more neural networks that are trained to map the application data models 314 with the comprehensive data model 318. In some implementations, the one or more neural networks may be trained to generate the model map 324.

As described with respect to FIG. 2 and elsewhere herein, an entity 326 that is external to the computing services provider and separate from the plurality of entities 308 may send a request 328 over one or more networks to the computing services provider to process data 330 stored in a set of data sources 332. The set of data sources 332 may be provisioned in a common data store 334. In some embodiments, the request 328 may be received by the application suggestion service 306. The request 328 may indicate a location of the data 330 to be processed in the set of data sources 332 and/or the common data stored 334.

The computing system of the computing services provider obtains a data model of the stored data, processes the data model, and provides an indication regarding one or more applications or services that may be configured to integrate with at least some of the stored data. In some implementations, the application suggestion service 306 may obtain a data model 336 from the set of data sources 332 or the common data stored 334. In some implementations, the application suggestion service 306 may generate, or call upon another service to generate, the data model 336 for the data 330 to be processed.

The application suggestion service 306 issues a request 338 to the mapping service 304 to map the data model 336 with the comprehensive data model 318. In some embodiments, the application suggestion service 306 may include the data model 336 with the request 338. In some embodiments, the application suggestions service 306 may store the data model 336 in the model storage 316 and provide an indication with the request 338 of a location of the data model 336 in the model storage 316. In response to the request 338, the mapping service 304 maps the data model 336 with the comprehensive data model 318. For instance, the mapping service 304 may determine links or correlations between attributes of the data model 336 and attributes of the comprehensive data model 318. As a more particular example, the mapping service 304 may determine that a data type in the data model 336 has a corresponding data type in the comprehensive data model 318, or that a relationship between data types or items in the data model 336 has a corresponding relationship in the comprehensive data model 318.

Based on the mapping between the data model 336 and the comprehensive data model 318, one or more data models of the application data models 314 may be identified as being a match or having a correspondence with the data model 336. The mapping service 304 may perform comparisons between (i) the map of the data model 336 with the comprehensive data model 318; and (ii) the maps between the application data models 314 with the comprehensive data model 318. As an example, the mapping service 304 may compare the map between the data model 336 and the comprehensive data model 318 with the model map 324 to determine common or similar correspondences between the two maps. The mapping service 304 may generate values or “scores” that indicate similarities or correlations between the mappings. Individual values may be associated with individual data models of the application data models 314. For instance, a high value for a first data model of the application data models 314 may indicate a high correlation between the first data model and the data model 336 whereas a low value may indicate a low correlation. A higher correlation between the mappings is an indication that a corresponding application of the applications 310 may be compatible with the data 330 to be processed.

The mapping service 304 sends a response 340 to the application suggestion service 306 indicating results of the mappings. The response 340 may include the aforementioned values associated with the comparisons or include another indication regarding correlation between the data model 336 and the application data models 314. The application suggestion service 306 identifies a set of the applications 310 on the platform 312 based on the indication(s) of correlation in the response 340. In some embodiments, the application suggestion service 306 may identify which of the applications 310 are associated with an indication of correspondence that exceeds a defined threshold value—for example, which of the applications 310 are associated with a value or “score” that exceeds a correlation threshold of 95%. In some embodiments, the application suggestion service 306 may identify a defined number (e.g., three, five) of applications having the highest indication of correspondence.

The application suggestion service 306 sends a communication 342 to the entity 326 recommending one or more applications 344 of the applications 310 on the platform 312 for processing the data 330. The application suggestion service 306, in some embodiments, may detect or monitor engagement (or the lack thereof) of the requestor 326 with the application(s) 344 suggested in the communication 342, as discussed with respect to FIG. 2. The application suggestion service 306 may detect, via the platform 312, whether the requestor 326 accesses any of the application(s) 344 suggested and, if so, which of the applications 344 the requestor 326 accesses. The application suggestion service 306 may detect the degree to which the requestor 326 uses or interacts with the application(s) 344 to process the data 330. For instance, the application suggestion service 306 may detect whether the requestor 326 successfully processes the data 330 using the application(s) 344 suggested. In some embodiments, the application suggestion service 306 may detect which of the application(s) 344 the requestor 326 does not engage or interact with. In some embodiments, the application suggestion service 306 may detect whether the requestor 326 discontinues using the application(s) 344 suggested with minimal use or after processing a portion of the data 330.

The application suggestion service 306 may generate feedback data 346 based on interactions (or lack thereof) of the requestor 326 with the application(s) 344 suggested and provide the feedback data 346 to the mapping service 304, as described with respect to FIG. 2. The feedback data 346 may indicate which of the application(s) 344 the requestor 326 engaged or interacted with, the degree of interaction, and/or which of the application(s) 344 the requestor 326 avoided interaction with, by way of non-limiting example.

The mapping service 304 may modify its performance based on the feedback data 346. In some embodiments, one or more neural networks of the mapping service 304 may be modified or trained using the feedback data 346 as training data. For instance, a neural network trained to generate and/or update the comprehensive data model 318 may be trained using the feedback data 346. As another example, a neural network trained to map data models (e.g., the data models 314, the data model 336) with the comprehensive data model 318 may be trained using the feedback data 346.

A computer system including the registration service 302, the mapping service 304, and the application suggestion service 306 achieves the aforementioned improvements in efficiency and operation described with respect to FIG. 2. Moreover, implementing the comprehensive data model 318 in the techniques and systems described herein significantly reduces the computational complexity to determine a mapping between the application data models 314 and the data model 336. In particular, mapping the data models according to the computer system and techniques described with respect to FIG. 2 is a computation having a complexity of M×N, where M is the number of applications 310 (each having a corresponding data model 314) and N is the number of third-party entities 326 having data 330 to be processed (each collection of data having a corresponding data model 336). By utilizing the comprehensive data model 318 of FIG. 3 in connection with the systems and techniques described herein, the computational complexity of the problem is M+N. As a result, the computing resources involved in mapping the data models and suggesting a set of applications for processing a collection of data (e.g., data 330) is significantly reduced and the overall process streamlined.

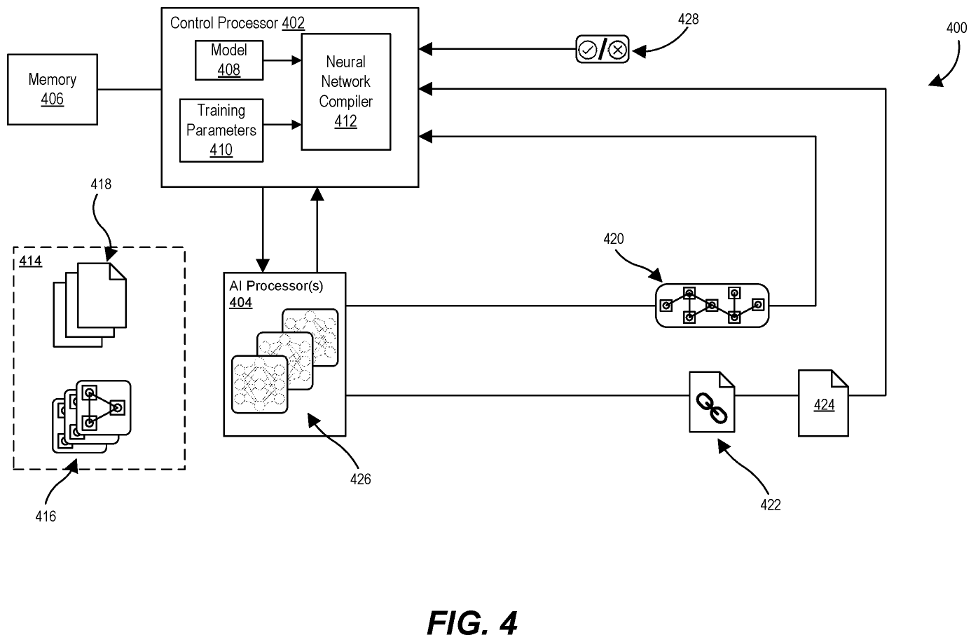

FIG. 4 illustrates an environment 400 in which one or more neural networks associated with a mapping service are trained according to one or more embodiments. In this example, one or more control processor(s) 402 may be in communication with one or more AI processor(s) 404. Control processor(s) 402 may include traditional CPUs, FPGAs, systems on a chip (SoC), application specific integrated circuits (ASICs), or embedded ARM controllers, for example, or other processors that can execute software and communicate with AI processor(s) 404 based on instructions in the software. AI processor(s) 404 may include graphics processors (GPUs), AI accelerators, or other digital processors optimized for AI operations (e.g., matrix multiplications versus Von Neuman Architecture processors such as the x86 processor). Example AI processor(s) may include GPUs (e.g., NVidia Volta® with 800 cores and 64 MultiAccumulators) or a Tensor Processor Unit (TPU) (e.g., 4 cores with 16k operations in parallel), for example.

In this example, a control processor 402 may be coupled to memory 406 (e.g., one or more non-transitory computer readable storage media) having stored thereon program code executable by control processor 402. The control processor 402 receives (e.g., loads) a neural network model 408 (hereinafter, “model”) and a plurality of training parameters 410 for training the model 408. The model 408 may comprise, for example, a graph defining multiple layers of a neural network with nodes in the layers connected to nodes in other layers and with connections between nodes being associated with trainable weights. The training parameters 410 (e.g., tuning parameters, model parameters) may comprise one or more values which may be adjusted to affect configuration and/or execution of the model 408. Other parameters or attributes may be included in the training parameters 410 that may be characterized and adjusted as would be apparent to those skilled in the art in light of the present disclosure. In some embodiments, the training parameters 410 may include one or more hyperparameters (e.g., parameters used to control learning of the neural network) as known to those skilled in the art.

The control processor 402 may also execute a neural network compiler 412. The neural network compiler 412 may comprise a program that, when executed, receives the model 408 and training parameters 410 and configures resources on one or more AI processors 404 to implement and execute model 408 in hardware. For instance, the neural network compiler 412 may receive and configure the model 408 based on one or more of the training parameters 410 to execute a training process executed on AI processor(s) 404. The neural network compiler 412 may cause the one or more AI processors 404 to implement calculations of input activations, weights, biases, backpropagation, etc., to perform the training process. The AI processor(s) 404, in turn, may use computing resources, as determined by the neural network compiler 412, to receive and process training data 414 with model 408 (e.g., the training process). The training data 414 may include data models 416 and/or enterprise data 418 to be processed, as described with respect to FIGS. 1, 2, 3, and elsewhere herein.

The computing resources may include, for example, registers, multipliers, adders, buffers, and other digital blocks used to perform operations to implement the model 408. The AI processor(s) 404 may perform numerous matrix multiplication calculations in a forward pass, compare outputs against known outputs for subsets of training data 414, and perform further matrix multiplication calculations in a backward pass to determine updates to various neural network training parameters, such as gradients, biases, and weights. This process may continue through multiple iterations as the training data 414 is processed. In some embodiments, AI processor(s) 404 may determine the weight updates according to a backpropagation algorithm that may be configured by the neural network compiler 412. Such backpropagation algorithms include stochastic gradient descent (SGD), Adaptive Moment Estimation (ADAM), and other algorithms known to those skilled in the art. Some of the training data 414 may be obtained from sources available to the computing service provider via the internet 236, 320, which may include data lakes, data warehouses, data sources, repositories, websites, or other similar sources.

During training of the model 408, one or more values for activations, biases, weights, gradients, or other parameter may be generated or updated for one or more layers, nodes, and/or connections of the model 408. During training, the AI processor(s) 404 may generate training information that is useable to determine a status or a progress of training the model 408. In some embodiments, the training data may include comprehensive data model(s) 420 and/or model map(s) 422, as described with respect to FIG. 3. In some embodiments, the training data may include correlation data 424 that includes values or “scores” indicating similarities or correlations between mappings by a neural network model. The AI processor(s) 404 may provide the training information to the control processor(s) 402. The AI processor(s) 404 and/or the control processor 402 may use the training information to determine whether to adjust various parameters or attributes of the neural network training process. The control processor 402 may obtain or possess training criteria for determining whether to adjust the training attributes or parameters.

In some embodiments, the training parameters 410 may be provided to the neural network compiler 412 for updating the implementation of the model 408 on AI processor(s) 404, the updated model 408 to be subsequently executed by the AI processor(s). One or more neural networks 426 compiled by the neural network compiler 412 are executing on the AI processor(s) 404. The one or more neural networks 426 may be used in connection with operation of the mapping service 204 and 304 described herein. The control processor(s) 102 may update the one or more neural networks 426 based on the comprehensive data model(s) 420, the model map(s) 422, and/or the correlation data 424. The control processor(s) 102 may iteratively train the one or more neural network(s) 426 until a set of training criteria are satisfied—for instance, until training loss of the neural network(s) 426 converges to within a desired threshold. In some embodiments, the control processor(s) 102 may continue training during operation of the computer systems described with respect to FIGS. 1, 2, and 3. For instance, the control processor(s) 102 may update the one or more neural networks 426 using feedback data 428 received as a result of suggesting, by an application suggestion service, application(s) to an external entity for processing data and/or monitoring engagement by the entity with the application(s).

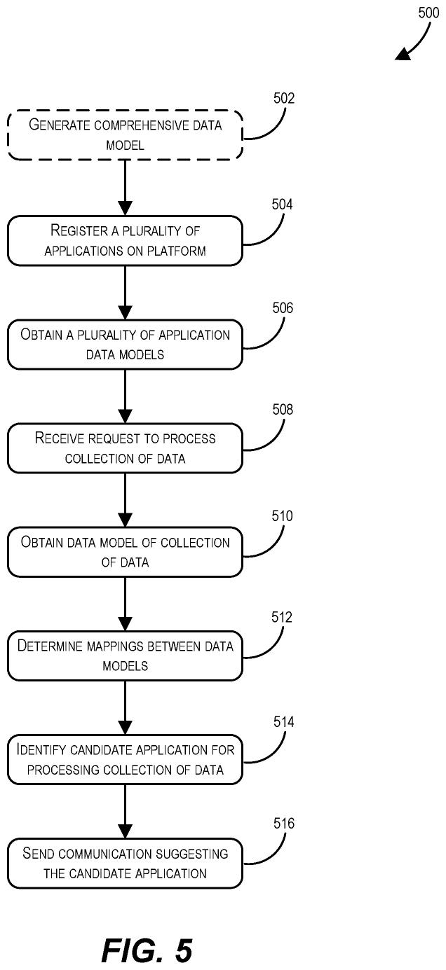

FIG. 5 illustrates a method 500 for determining a set of candidate applications or services for processing data associated with an external entity according to one or more embodiments. The method 500 may be performed by a computer system comprising the registration service, the mapping service, and the application suggestion service described herein. Various features and details regarding the method 500 are described elsewhere herein, so additional description thereof is omitted for brevity. Some or all of the operations shown in FIG. 5 may be performed. The method 500 may be performed in a different order than shown in FIG. 5 and/or described herein without departing from the scope of the present disclosure.

The method 500 may include generating, at 502, a comprehensive data model based on a plurality of first data models, as described with respect to FIG. 3 and elsewhere herein. The first data models may be obtained from one or more sources, such as repositories, data lakes, data warehouses, websites, and/or provided by third-party entities. In some embodiments, the first data models may be generated based on one or more data sets received. The comprehensive data model generated in 502 is specific to an industry in some embodiments. The comprehensive data model may be generated by the mapping service described herein.

At 504, the method 500 includes registering a plurality of applications provided by third party entities. For instance, the registration service may receive a set of requests from third-party entities to register the applications on the platform and may register the applications provided by the third-party entities on the platform. The method 500 also includes obtaining, at 506, a plurality of application data models that are associated with the plurality of applications registered in 504. In some embodiments, the registration service may generate, or call upon another service to generate, at least some of the plurality of application data models in 506. In some embodiments, the third-party entities may provide at least some of the plurality of application data models to the registration service in connection with the request(s) to register the applications.

The method 500 may further include receiving, at 508, a request from an external entity to process a collection of data using an application registered on the platform. The request may be received by the application suggestion service or another service described herein. The external entity may provide the collection of data or an indication of the location of the location (e.g., in a data lake). At 510, the method 500 involves obtaining a second data model that corresponds to the collection of data to be processed. In some embodiments, the application suggestion service generates, or calls upon another service to generate, the second data model based on the collection of data to be processed. In some embodiments, the external entity may provide the second data model in connection with the request or the collection of data to be processed.

At 512, the method 500 involves mapping the second data model with the plurality of application data models. Mapping in 512 is performed by the mapping service described herein. In some embodiments, mapping by the mapping service may include mapping the plurality of second data models with the comprehensive data model, mapping the second data model with the comprehensive data model, and then determining correlations between attributes of the data model and attributes of the plurality of application data models based on the mappings. In some embodiments, the mapping service may map the second data model with the plurality of second application data models without the use of the comprehensive data model.

The method 500 further involves identifying, at 514, one or more candidate applications of the plurality of applications stored in model storage based on the mappings in 512. Identifying, in 514, may be performed by the application suggestion service based on the mappings or by the mapping service. As a result of identifying the one or more candidate applications in 514, the method 500 proceeds to send, at 516, a communication suggesting the one or more candidate applications to the external entity. In some embodiments, the application suggestion service may detect a level of engagement by the external entity with the one or more candidate applications and may generate feedback data based on the level of engagement. In some embodiments, the feedback data may be provided to the mapping service to modify the performance thereof. For instance, the mapping service may include one or more neural networks that are trained to, e.g., generate a comprehensive data model and/or perform mappings between data models, as described herein. Additional features of the method 500 described herein may be performed.

### Example Computer System

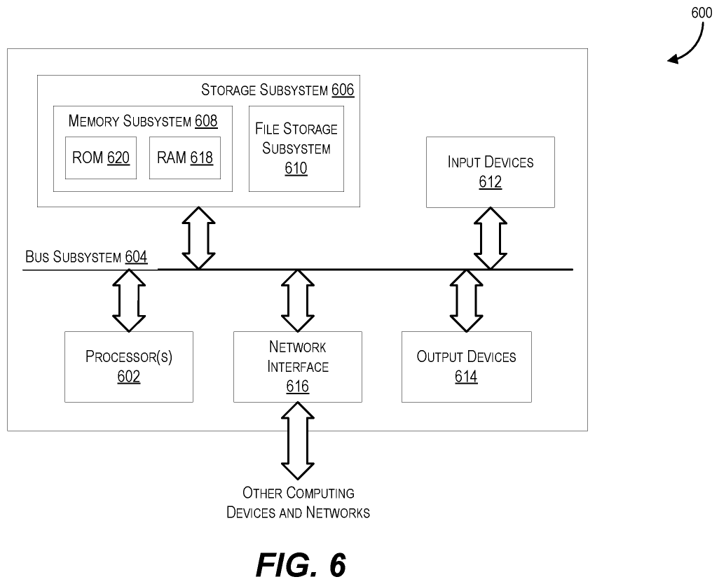

FIG. 6 depicts a simplified block diagram of an example computer system 600 according to certain embodiments. Computer system 600 can be used to implement any of the computing devices, systems, or servers described in the foregoing disclosure. As shown in FIG. 6, computer system 600 includes one or more processors 602 that communicate with a number of peripheral devices via a bus subsystem 604. These peripheral devices include a storage subsystem 606 (comprising a memory subsystem 608 and a file storage subsystem 160), user interface input devices 612, user interface output devices 614, and a network interface subsystem 616.

Bus subsystem 604 can provide a mechanism for letting the various components and subsystems of computer system 600 communicate with each other as intended. Although bus subsystem 604 is shown schematically as a single bus, alternative embodiments of the bus subsystem can utilize multiple busses.

Network interface subsystem 616 can serve as an interface for communicating data between computer system 600 and other computer systems or networks. Embodiments of network interface subsystem 616 can include, e.g., an Ethernet card, a Wi-Fi and/or cellular adapter, a modem (telephone, satellite, cable, ISDN, etc.), digital subscriber line (DSL) units, and/or the like.

User interface input devices 612 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 600.

User interface output devices 614 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 600.

Storage subsystem 606 includes a memory subsystem 608 and a file/disk storage subsystem 610. Subsystems 618 and 620 represent non-transitory computer-readable storage media that can store program code and/or data that provide the functionality of embodiments of the present disclosure.

Memory subsystem 608 includes a number of memories including a main random access memory (RAM) 618 for storage of instructions and data during program execution and a read-only memory (ROM) 620 in which fixed instructions are stored. File storage subsystem 610 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 600 is illustrative and many other configurations having more or fewer components than system 600 are possible.

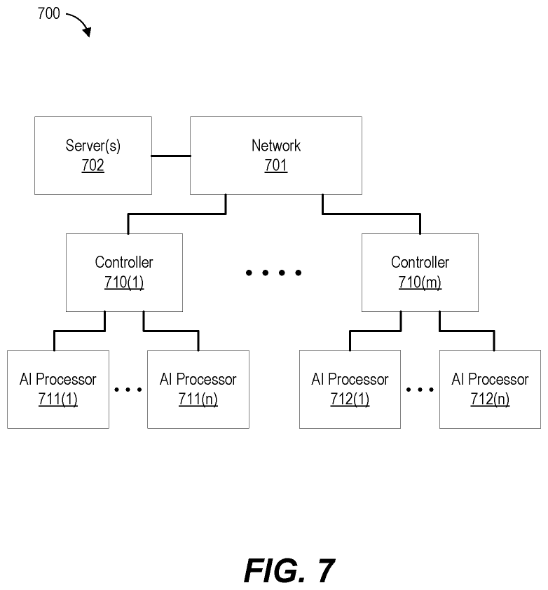

FIG. 7 illustrates an artificial neural network processing system according to some embodiments. In various embodiments, neural networks (e.g., neural network model 310) according to the present disclosure may be implemented and trained in a hardware environment comprising one or more neural network processors (e.g., AI processor(s)). A neural network processor may refer to various graphics processing units (GPU), field programmable gate arrays (FPGA), or a variety of application specific integrated circuits (ASICs) or neural network processors comprising hardware architectures optimized for neural network computations, for example. In this example environment, one or more servers 702, which may comprise architectures illustrated in FIG. 6 above, may be coupled to a plurality of controllers 710(1)-710(M) over a communication network 701 (e.g., switches, routers, etc.). Controllers 710(1)-710(M) may also comprise architectures illustrated in FIG. 6 above. Each controller 710(1)-710(M) may be coupled to one or more neural network (NN) processors, such as processing units 711(1)-711(N) and 712(1)-712(N), for example. NN processing units 711(1)-711(N) and 712(1)-712(N) may include a variety of configurations of functional processing blocks and memory optimized for neural network processing, such as training or inference. The NN processors are optimized for neural network computations. Server 702 may configure controllers 710 with NN models as well as input data to the models, which may be loaded and executed by NN processing units 711(1)-711(N) and 712(1)-712(N) in parallel, for example. Models may include layers and associated weights as described above, for example. NN processing units may load the models and apply the inputs to produce output results. NN processing units may also implement training algorithms described herein, for example.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The various embodiments further can be implemented in a wide variety of operating environments, which in some cases can include one or more user computers, computing devices or processing devices which can be used to operate any of a number of applications. User or client devices can include any of a number of computers, such as desktop, laptop or tablet computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network. These devices also can include virtual devices such as virtual machines, hypervisors and other virtual devices capable of communicating via a network.

Various embodiments of the present disclosure utilize at least one network that would be familiar to those skilled in the art for supporting communications using any of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, a satellite network, and any combination thereof. In some embodiments, connection-oriented protocols may be used to communicate between network endpoints. Connection-oriented protocols (sometimes called connection-based protocols) are capable of transmitting data in an ordered stream. Connection-oriented protocols can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In embodiments utilizing a web server, the web server can run any of a variety of server or mid-tier applications, including Hypertext Transfer Protocol (“HTTP”) servers, FTP servers, Common Gateway Interface (“CGI”) servers, data servers, Java servers, Apache servers, and business application servers. The server(s) also may be capable of executing programs or scripts in response to requests from user devices, such as by executing one or more web applications that may be implemented as one or more scripts or programs written in any programming language, such as Java®, C, C # or C++, or any scripting language, such as Ruby, PHP, Perl, Python or TCL, as well as combinations thereof. The server(s) may also include database servers, including without limitation those commercially available from Oracle®, Microsoft®, Sybase and IBM® as well as open-source servers such as MySQL, Postgres, SQLite, MongoDB, and any other server capable of storing, retrieving, and accessing structured or unstructured data. Database servers may include table-based servers, document-based servers, unstructured servers, relational servers, non-relational servers, or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU” or “processor”), at least one input device (e.g., a mouse, keyboard, controller, touch screen, or keypad) and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. In addition, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as, but not limited to, volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). The number of items in a plurality is at least two, but can be more when so indicated either explicitly or by context.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. In some embodiments, the code is stored on set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media may comprise multiple non-transitory computer-readable storage media and one or more of individual non-transitory storage media of the multiple non-transitory computer-readable storage media may lack all of the code while the multiple non-transitory computer-readable storage media collectively store all of the code. Further, in some examples, the executable instructions are executed such that different instructions are executed by different processors. As an illustrative example, a non-transitory computer-readable storage medium may store instructions. A main CPU may execute some of the instructions and a graphics processor unit may execute other of the instructions. Generally, different components of a computer system may have separate processors and different processors may execute different subsets of the instructions.

Accordingly, in some examples, computer systems are configured to implement one or more services that singly or collectively perform operations of processes described herein. Such computer systems may, for instance, be configured with applicable hardware and/or software that enable the performance of the operations. Further, computer systems that implement various embodiments of the present disclosure may, in some examples, be single devices and, in other examples, be distributed computer systems comprising multiple devices that operate differently such that the distributed computer system performs the operations described herein and such that a single device may not perform all operations.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

### Further Embodiments

In various embodiments, the present disclosure includes an automated workflow process for determining a set of candidate applications or services for processing data associated with an external entity. The following embodiments may be implemented alone or in any combination thereof and may further be embodied with other features described herein.

Some embodiments of the present disclosure include a computer system comprising one or more processors; and a non-transitory computer readable medium storing a set of instructions that, as a result of execution by the one or more processors, cause the one or more processors to obtain a plurality of application data models associated with of a plurality of applications on a cloud-based platform; obtain a data model corresponding to a collection of data to be processed; determine mappings between the data model and the plurality of application data models; identify a candidate application of the plurality of applications for processing the collection of data based on the mappings; and send, over one or more networks to an external entity associated with the data model, a communication suggesting the candidate application for processing the collection of data, thereby reducing computing resources involved in identifying an application on the cloud-based platform for processing the collection of data.

In some embodiments, execution of the set of instructions causes the one or more processors to generate a comprehensive data model based on a plurality of data models, wherein the mappings are generated based at least in part on the comprehensive data model. In some embodiments, execution of the set of instructions causes the one or more processors to determine a first mapping between the plurality of application data models and the comprehensive data model; and determine a second mapping between the data model and the comprehensive data model, wherein the mappings are generated based on the first mapping and the second mapping.

In some embodiments, execution of the set of instructions causes the one or more processors to register the plurality of applications for availability on the cloud-based platform, wherein the plurality of application data models are obtained in connection with registration of the plurality of applications.

In some embodiments, execution of the set of instructions causes the one or more processors to detect a level of engagement by external entity with the candidate application; and generate feedback data regarding the mappings based on the level of engagement.

In some embodiments, the comprehensive data model is specific to an industry.

In some embodiments, the computer system comprises one or more neural networks trained to determine the mappings between the data model and the plurality of application data models, and execution of the set of instructions causes the one or more processors to provide the data model and the plurality of application data models as input to the one or more neural networks. In some embodiments, execution of the set of instructions causes the one or more processors to train the set of neural networks by at least providing a plurality of data models as training data to the one or more neural networks and adjusting parameters of the one or more neural networks based on a result of neural network output.

In some embodiments, execution of the set of instructions causes the one or more processors to determine correlations between attributes of the data model and attributes of the plurality of application data models.

Some embodiments of the present disclosure include a method comprising obtaining a plurality of application data models associated with of a plurality of applications on a cloud-based platform; obtaining a data model corresponding to a collection of data to be processed; mapping the data model with the plurality of application data models; determining a candidate application of the plurality of applications for processing the collection of data based on the mappings; and sending, over one or more networks to an external entity associated with the data model, a communication suggesting the candidate application for processing the collection of data, thereby reducing computing resources involved in identifying an application on the cloud-based platform for processing the collection of data.

In some embodiments, the method comprises generating a comprehensive data model based on a plurality of data models, wherein mapping the data model with the plurality of application models is based at least in part on the comprehensive data model.

In some embodiments, the method comprises generating a model map based on comparison between a comprehensive data model and the plurality of application data models, wherein mapping the data model with the plurality of application models involves the comparison of the data model with the model map.

In some embodiments, the method comprises detecting a level of engagement by the external entity with the candidate application; and generating feedback data regarding the mappings based on the level of engagement.

In some embodiments, mapping includes determining correlations between attributes of the data model and attributes of the plurality of application data models.

In some embodiments, the method comprises receiving, over the network from the external entity, a request to identify the candidate application for processing the collection of data, wherein the data model is obtained in connection with the request.

Some embodiments of the present disclosure include a non-transitory computer readable medium having stored thereon program code executable by one or more processors, execution of the program code causing the one or more processors to obtain a plurality of application data models associated with of a plurality of applications on a cloud-based platform; obtain a data model corresponding to a collection of data to be processed; determine mappings between the data model and the plurality of application data models; identify a candidate application of the plurality of applications for processing the collection of data based on the mappings; and send, over one or more networks to an external entity associated with the data model, a communication suggesting the candidate application for processing the collection of data, thereby reducing computing resources involved in identifying an application on the cloud-based platform for processing the collection of data.

In some embodiments, execution of the program code stored on the non-transitory computer readable medium causes the one or more processors to generate a comprehensive data model based on a plurality of data models, wherein the mappings are generated based at least in part on the comprehensive data model.

In some embodiments, execution of the program code stored on the non-transitory computer readable medium causes the one or more processors to implement one or more neural networks trained to generate the mappings between the data model and the plurality of application data models; and provide the data model and the plurality of application data models as input to the one or more neural networks.

In some embodiments, execution of the program code stored on the non-transitory computer readable medium causes the one or more processors to perform fuzzy hashing to determine the mappings.

In some embodiments, execution of the program code stored on the non-transitory computer readable medium causes the one or more processors to detect a level of engagement by external entity with the candidate application; and generate feedback data regarding the mappings based on the level of engagement.

Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

1. A computer system comprising:
one or more processors; and
a hardware storage device storing a set of instructions that, as a result of execution by the one or more processors, cause the one or more processors to:
obtain a plurality of application data models associated with of a plurality of applications on a cloud-based platform;
obtain a data model corresponding to a collection of data to be processed;
determine mappings between the data model and the plurality of application data models;
identify a candidate application of the plurality of applications for processing the collection of data based on the mappings; and
send, over one or more networks to an external entity associated with the data model, a communication suggesting the candidate application for processing the collection of data, thereby reducing computing resources involved in identifying an application on the cloud-based platform for processing the collection of data.

2. The computer system of claim 1, execution of the set of instructions causing the one or more processors to:
generate a comprehensive data model based on a plurality of data models, wherein the mappings are generated based at least in part on the comprehensive data model.

3. The computer system of claim 2, execution of the set of instructions causing the one or more processors to:
determine a first mapping between the plurality of application data models and the comprehensive data model; and
determine a second mapping between the data model and the comprehensive data model, wherein the mappings are generated based on the first mapping and the second mapping.

4. The computer system of claim 1, execution of the set of instructions causing the one or more processors to:
register the plurality of applications for availability on the cloud-based platform, wherein the plurality of application data models are obtained in connection with registration of the plurality of applications.

5. The computer system of claim 1, execution of the set of instructions causing the one or more processors to:
detect a level of engagement by external entity with the candidate application; and
generate feedback data regarding the mappings based on the level of engagement.

6. The computer system of claim 1, wherein the comprehensive data model is specific to an industry.

7. The computer system of claim 1, the computer system comprising:
one or more neural networks trained to determine the mappings between the data model and the plurality of application data models, wherein execution of the set of instructions causes the one or more processors to:
provide the data model and the plurality of application data models as input to the one or more neural networks.

8. The computer system of claim 7, execution of the set of instructions causing the one or more processors to:
train the set of neural networks by at least providing a plurality of data models as training data to the one or more neural networks and adjusting parameters of the one or more neural networks based on a result of neural network output.

9. The computer system of claim 1, execution of the set of instructions causing the one or more processors to:
determine correlations between attributes of the data model and attributes of the plurality of application data models.

10. A method comprising:
obtaining a plurality of application data models associated with of a plurality of applications on a cloud-based platform;
obtaining a data model corresponding to a collection of data to be processed;
mapping the data model with the plurality of application data models;
determining a candidate application of the plurality of applications for processing the collection of data based on the mappings; and
sending, over one or more networks to an external entity associated with the data model, a communication suggesting the candidate application for processing the collection of data, thereby reducing computing resources involved in identifying an application on the cloud-based platform for processing the collection of data.

11. The method of claim 10, comprising:
generating a comprehensive data model based on a plurality of data models, wherein mapping the data model with the plurality of application models is based at least in part on the comprehensive data model.

12. The method of claim 10, comprising:
generating a model map based on comparison between a comprehensive data model and the plurality of application data models, wherein mapping the data model with the plurality of application models involves the comparison of the data model with the model map.

13. The method of claim 10, comprising:
detecting a level of engagement by the external entity with the candidate application; and
generating feedback data regarding the mappings based on the level of engagement.

14. The method of claim 10, wherein mapping includes determining correlations between attributes of the data model and attributes of the plurality of application data models.

15. The method of claim 10, comprising:
receiving, over the network from the external entity, a request to identify the candidate application for processing the collection of data, wherein the data model is obtained in connection with the request.

16. A hardware storage device having stored thereon program code executable by one or more processors, execution of the program code causing the one or more processors to:
obtain a plurality of application data models associated with of a plurality of applications on a cloud-based platform;
obtain a data model corresponding to a collection of data to be processed;
determine mappings between the data model and the plurality of application data models;
identify a candidate application of the plurality of applications for processing the collection of data based on the mappings; and
send, over one or more networks to an external entity associated with the data model, a communication suggesting the candidate application for processing the collection of data, thereby reducing computing resources involved in identifying an application on the cloud-based platform for processing the collection of data.

17. The hardware storage device of claim 16, wherein execution of the program code causes the one or more processors to:
generate a comprehensive data model based on a plurality of data models, wherein the mappings are generated based at least in part on the comprehensive data model.

18. The hardware storage device of claim 16, wherein execution of the program code causes the one or more processors to:
implement one or more neural networks trained to generate the mappings between the data model and the plurality of application data models; and
provide the data model and the plurality of application data models as input to the one or more neural networks.

19. The hardware storage device of claim 16, wherein execution of the program code causes the one or more processors to:
perform fuzzy hashing to determine the mappings.

20. The hardware storage device of claim 16, wherein execution of the program code further causes the one or more processors to:
detect a level of engagement by external entity with the candidate application; and
generate feedback data regarding the mappings based on the level of engagement.
